(19) United States
(12) Patent Application Publication
(10) Pub. No.: US 2023/0335320 A1
(43) Pub. Date: Oct. 19, 2023

(54) METHOD FOR PRODUCING A PERMANENT MAGNET FROM A MAGNETIC STARTING MATERIAL

(71) Applicant: MIMplus Technologies GmbH & Co. KG, Ispringen (DE)

(72) Inventors: Johannes MAURATH, Ettlingen (DE); Simone SCHUSTER, Renningen (DE)

(73) Assignee: MIMplus Technologies GmbH & Co. KG, Ispringen (DE)

(21) Appl. No.: 18/027,160

(22) PCT Filed: Sep. 21, 2021
(86) PCT No.: PCT/EP2021/075986

§ 371 Date: Mar. 20, 2023

(30) Foreign Application Priority Data
Sep. 22, 2020 (DE) 10 2020 211 857.4

(51) Int. Cl. H01F 1/057; H01F 41/02; C22C 38/00

(52) U.S. Cl. CPC H01F 1/0577; H01F 1/0573; H01F 41/0266; C22C 38/005; C22C 2202/02

(57) ABSTRACT

The invention relates to a method of producing a permanent magnet from a powdered magnetic base material. The powdered magnetic base material is shaped, wherein a raw form is prepared. The raw form is sintered, wherein the permanent magnet is produced. In at least one step of the method, between particles of the powdered magnetic base material an electrical resistance layer having a lower electrical conductivity than the powdered magnetic base material is formed.

The invention relates to a method for producing a permanent magnet from a magnetic base material.

Permanent magnets from the rare-earth group are used in a variety of technical applications and are characterized by a particularly high energy product. Neodymium-iron-boron magnets in particular have an energy product of up to 400 kJ/m³. When permanent magnets are used together with moving, current-carrying coils, electromagnetic induction takes place in the electrically conductive components involved. In a permanent magnet, this magnetic induction leads to eddy currents. The eddy currents cause the permanent magnet to heat up strongly, which leads to a short-term reduction in the magnetic output or to permanent thermal damage and demagnetization of the permanent magnet.

The invention is therefore based on the problem of providing a method for producing a permanent magnet from a magnetic base material, wherein the above-mentioned disadvantages are at least partially eliminated, preferably avoided.

The problem is solved by providing the present technical teaching, in particular the teaching of the independent claims as well as the embodiments disclosed in the dependent claims and the description.

In particular, the problem is solved by providing a method for producing a permanent magnet from a powdered magnetic base material, wherein the magnetic base material is shaped, wherein a raw form is created. The raw form is sintered, wherein the permanent magnet is produced. In at least one step of the method, an electrical resistance layer having a lower electrical conductivity than the magnetic base material is formed between particles of the magnetic base material. Advantageously, permanent magnets having reduced electrical conductivity are produced by means of the method. Thus, these permanent magnets are less susceptible to eddy currents, and thus heating of the permanent magnets during operation, in particular during operation in an electric motor, is reduced, in particular avoided.

In an embodiment of the method, the electrical resistance layer is formed as at least one closed layer.

In a further embodiment of the method, the electrical resistance layer is formed as a non-closed layer, in particular as layer fragments present in certain areas.

In a further embodiment of the method, the electrical resistance layer is formed in the form of finely distributed regions on the particles of the magnetic base material and/or at the grain boundaries between the particles of the magnetic base material.

Advantageously, the method is suitable for a powdered magnetic base material formed on the basis of a newly melted alloy, in particular in the form of a cast ingot or in the form of melt-spun material. Alternatively or additionally, the method is suitable for recycled magnetic material and/or contaminated recycled magnetic material. Additionally, material obtained by recycling is preferably alloyed with a rare-earth, preferably in powdered form, to improve its properties.

The magnetic base material is preferably in a pure form or in a hydrogenated form. US patent application US 2013/0263699 A1 and German patent DE 198 43 883 C1 describe a method, called hydrogen decrepitation (HD), for producing a hydrogenated form of the magnetic base material by means of a hydrogen-induced decay.

Preferably, the raw form has the magnetic base material at a volume fraction of 30% to 70%.

Preferably, the raw form is sintered at a temperature of 1000° C. to 1200° C. Particularly preferably, the sintering is carried out for a duration of 30 minutes to 300 minutes.

According to a further development of the invention, it is provided that a material made from particles of an RₓT_{y}B alloy is used as the magnetic base material. Preferably, as magnetic base material a material is used which has particles of an RₓT_{y}B alloy or consists of particles of an RₓT_{y}B alloy. In particular, preferably, the magnetic base material used is a material comprising particles of an NdₓFe_{y}B alloy or consisting of particles of an NdₓFe_{y}B alloy.

Preferably, the magnetic base material used is a material made of particles of an RₓT_{y}B alloy and particles of a rare-earth-rich phase. In particular, the magnetic base material preferably has or consists of a mixture of particles of an RₓT_{y}B alloy and particles of a rare-earth-rich phase. Preferably, the magnetic base material used is a material comprising or consisting of particles of an NdₓFe_{y}B alloy and particles of a neodymium-rich phase. In particular, the magnetic base material preferably comprises or consists of a mixture of particles of an NdₓFe_{y}B alloy and particles of a neodymium-rich phase.

In the context of the present technical teachings, R represents a rare-earth element, T represents at least one element selected from a group consisting of iron and cobalt, and B represents the element boron. In particular, the elements iron and cobalt partially or completely substitute each other such that either only iron or only cobalt or any iron-cobalt mixture is present. Preferably, the rare-earth element is neodymium. In a preferred embodiment, the RₓT_{y}B alloy additionally comprises another element, preferably a metal, in particular a transition metal selected from a group consisting of aluminium, copper, zirconium, gallium, hafnium, and niobium, preferably in trace amounts.

Preferably, the magnetic base material has or consists of particles of an Nd₂Fe₁₄B alloy.

Preferably, the rare-earth-rich phase, in particular the neodymium-rich phase, has at least one rare-earth element, in particular neodymium, or a chemical compound of this rare-earth element, in particular of neodymium. In addition, the rare-earth-rich phase, in particular the neodymium-rich phase, preferably contains at least one further element of the RₓT_{y}B alloy, in particular the NdₓFe_{y}B alloy. Alternatively or additionally, the at least one rare-earth element, in particular neodymium, is present in a hydrogenated form. Preferably, the neodymium-rich phase has NdH₂ and/or NdH_{2,7} or consists of NdH₂ and/or NdH_{2,7}. Alternatively, in a preferred configuration, it is possible that the rare-earth-rich phase, in particular the neodymium-rich phase, consists of at least one rare-earth element, in particular of neodymium, or of a chemical compound of this rare-earth element, in particular of neodymium.

The rare-earth-rich phase preferably forms a phase in the microstructure of the permanent magnet which is located at grain boundaries of the microstructure.

According to a further development of the invention, it is provided that the magnetic base material is mixed with an organic binder, wherein a mixture of the magnetic base material and the organic binder is obtained. The raw form is created from the mixture, wherein the organic binder is at least partially removed from the raw form prior to sintering. Advantageously, the magnetic base material is incorporated into the organic binder in powdered form. Furthermore, forming the raw form from the mixture is possible in a simple manner.

Preferably, the organic binder is selected from a group consisting of a solvent, an oxygen-containing polymer, a halogen-containing polymer, a nitrogen-containing polymer, a carbon-containing polymer, a silicon-containing polymer, a sulfur-containing polymer, a boron-containing polymer, polyoxymethylene, polypropylene, paraffin wax, polyethylene and polyamide. In particular, the organic binder is liquid or solid under normal conditions, in particular at 1013 mbar and room temperature, in particular 25° C.

In an embodiment of the method, the organic binder is removed from the raw form by means of thermal debinding, in particular thermal decomposition.

In a further embodiment of the method, the organic binder is partially removed from the raw form by means of solvent extraction. Thereafter, the organic binder is removed from the raw form by means of thermal debinding, in particular thermal decomposition.

In a further embodiment of the method, the organic binder is chemically cleaved by means of a chemical reaction. Thereafter, the organic binder is removed from the raw form by means of thermal debinding, in particular thermal decomposition.

Particularly preferably, the raw form is thermally debinded, in particular thermally decomposed, at a temperature of 150° C. to 900° C. In particular, the thermal debinding, in particular thermal decomposition, is carried out for a duration of 3 hours to 16 hours. Particularly preferably, at least one temperature selected from a group consisting of 150° C., 200° C., 250° C., 300° C., 350° C., 400° C., 450° C., 500° C., 550° C., 600° C., 650° C., 700° C., 750° C., 800° C., 850° C. and 900° C. is kept constant for a duration of 30 minutes to 180 minutes during the thermal debinding.

According to a further development of the invention, it is provided that the electrical resistance layer is formed from the organic binder. Preferably, the organic binder is partially, in particular not completely, removed from the raw form prior to sintering of the raw form. The parts of the binder remaining in the raw form remain in the raw form during sintering and are deposited around the particles of the magnetic base material and/or at the grain boundaries. In particular, the organic binder has a lower electrical conductance than the magnetic base material. It is also possible that the parts of the binder remaining in the raw form are chemically modified during sintering and in this way form the electrical resistance layer.

Preferably, the raw form, in particular before debinding and in particular when the electrical resistance layer is formed from the organic binder, has the organic binder with a volume fraction of from 0.01% to 50%, preferably from 1% to 10%.

According to a further development of the invention, it is provided that the magnetic base material is mixed with at least one resistance building substance. The electrical resistance layer is formed from the at least one resistance building substance, wherein the at least one resistance building substance is preferably selected from a group consisting of an organic substance, a rare-earth compound, a ceramic and a reaction gas. Advantageously, chemical products, i.e. in particular chemical compounds and/or decay products, which have a lower electrical conductance than the magnetic base material are formed from the at least one resistance building substance—in particular during sintering. These chemical products accumulate at the grain boundaries of the microstructure during sintering and thus reduce the electrical conductivity of the permanent magnet.

Preferably, the raw form, in particular before debinding, has the resistance building substance with a volume fraction of from 0.01% to 50%, preferably from 1% to 10%.

In an embodiment of the method, the at least one resistance building substance reacts with the magnetic base material. The reaction products, in particular the reaction products at the surface of the particles of the magnetic base material, form the electrical resistance layer.

In a further embodiment of the method, the resistance building substance, in particular the organic substance and/or the rare-earth compound, accumulates between the particles of the magnetic base material. The particles of the resistance building substance and/or the layers of the resistance building substance, in particular the organic substance and/or the rare-earth compound, form the electrical resistance layer.

In a further embodiment of the method, the magnetic base material is mixed with an organic binder and with at least one resistance building substance, in particular an organic substance and/or at least one rare-earth compound. Advantageously, when an organic binder is used, better mixing of the individual constituents takes place. Particles of the resistance building substance, which are preferably embedded in the organic binder, accumulate between the particles of the magnetic base material during sintering. The resistance building substance and preferably the organic binder the electrical resistance layer of the permanent magnet.

In a further embodiment of the method, the magnetic base material is mixed with an organic binder and a resistance building substance, in particular at least one organic substance and/or at least one rare-earth compound. Particles of the resistance building substance embedded in the organic binder react with the magnetic base material. In particular, the organic binder serves as a catalyst for the reaction. The reaction products, in particular the reaction products at the surface of the particles of the magnetic base material, form the electrical resistance layer.

In a further embodiment of the method, the magnetic base material is mixed with an organic binder and a resistance building substance, in particular at least one organic substance and/or at least one rare-earth compound. The resistance building substance reacts with the organic binder. The reaction products accumulate between the particles of the magnetic base material during sintering and form the electrical resistance layer of the permanent magnet.

In a further embodiment of the method, the magnetic base material is mixed with ceramic particles as a resistance building substance and preferably an organic binder. Advantageously, the ceramic particles have a low electrical conductance. During sintering, the ceramic particles accumulate at the grain boundaries of the microstructure and/or in triple points of the microstructure and thus form the electrical resistance layer of the permanent magnet. Advantageously, this reduces the electrical conductivity of the permanent magnet and reduces eddy currents within the permanent magnet.

In the context of the present technical teachings, a grain boundary of a microstructure is a region in the microstructure between two immediately adjacent grains of the microstructure. In particular, two immediately adjacent grains of the microstructure are in contact in at least one region.

In the context of the present technical teachings, a triple point of the microstructure is an area in the microstructure between a plurality of immediately adjacent grains, in particular at least three immediately adjacent grains, of the microstructure. In particular, a plurality of directly adjacent grains, in particular at least three directly adjacent grains, of the microstructure are in contact in at least one region.

According to a further development of the invention, it is provided that the organic substance is selected from a group consisting of a solvent, an oxygen-containing polymer, a halogen-containing polymer, a nitrogen-containing polymer, a carbon-containing polymer, a silicon-containing polymer, a sulfur-containing polymer, and a boron-containing polymer. In particular, the organic substance is liquid or solid at room temperature.

In an embodiment of the method, the organic substance is selected from a group consisting of at least one wax, at least one thermoplastic resin, at least one alcohol, at least one silicone, and at least one fluorochlorohydrocarbon.

According to a further development of the invention, it is provided that the rare-earth compound is selected from a group consisting of a carbon-containing rare-earth compound, a sulfur-containing rare-earth compound, an oxygen-containing rare-earth compound, a nitrogen-containing rare-earth compound, a boron-containing rare-earth compound, a silicon-containing rare-earth compound, a fluorine-containing rare-earth compound and a chlorine-containing rare-earth compound. Preferably, the rare-earth compound is transported to the surfaces of the particles of the magnetic base material by means of the organic binder.

According to a further development of the invention, it is provided that the ceramic is selected from a group consisting of an oxide ceramic, a carbide ceramic and a nitride ceramic. In an embodiment of the invention, the ceramic is provided in the form of ceramic particles having a preferred particle size of 0.01 μm to 20 μm. Advantageously, ceramic particles are poor electrical conductors, so that the electrical conductivity of the permanent magnet can be reduced when the ceramic particles are enriched at the grain boundaries.

Preferably, the oxide ceramic is selected from a group consisting of aluminium oxide, zirconium oxide and titanium oxide.

According to a further development of the invention, it is provided that the reaction gas is selected from a group consisting of an oxygen-containing gas, a nitrogen-containing gas, a carbon-containing gas, a fluorine-containing gas, a chlorine-containing gas, a sulfur-containing gas and a hydrogen-containing gas.

Preferably, the magnetic base material is treated with the reaction gas at a temperature of from 20° C. to 250° C., more preferably from 100° C. to 250° C.

In an embodiment, at least one organic substance and/or at least one rare-earth compound and/or at least one reaction gas are mixed with the magnetic base material. In particular, the at least one organic substance and/or the at least one rare-earth compound and/or the at least one reaction gas form the electrical resistance layer. Alternatively or additionally, the at least one organic substance and/or the at least one rare-earth compound and/or the at least one reaction gas react with each other, and at least one resulting reaction product forms the electrical resistance layer. Alternatively or additionally, the at least one organic substance and/or the at least one rare-earth compound and/or the at least one reaction gas acts as a catalyst in forming the electrical resistance layer. Alternatively or additionally, the magnetic base material acts as a catalyst in a reaction of the at least one organic substance and/or the at least one rare-earth compound and/or the at least one reaction gas with each other to form the electrical resistance layer.

According to a further development of the invention, it is provided that the mixing of the magnetic base material with the at least one resistance building substance is carried out at a temperature of at least 20° C. to at most 1100° C. Preferably, the temperature effect causes activation of the at least one resistance building substance. Alternatively or additionally, the resistance building substance decomposes under the effect of temperature to form the resistance building layer.

Preferably, the mixing is performed at a temperature of at least 60° C., more preferably at least 150° C. Alternatively or additionally, the mixing is preferably carried out at a temperature of at most 250° C., particularly preferably of at most 200° C.

According to a further development of the invention, it is provided that the magnetic base material is treated with a pretreatment gas, wherein the electrical resistance layer is generated by means of the pretreatment gas.

Preferably, the magnetic base material is treated with the pretreatment gas at a temperature of from 20° C. to 250° C., more preferably from 100° C. to 250° C.

In an embodiment of the method, the pretreatment gas is selected from a group consisting of an argon-containing gas, an oxygen-containing gas, a nitrogen-containing gas, a carbon-containing gas, a fluorine-containing gas, a chlorine-containing gas, a sulfur-containing gas, and a hydrogen-containing gas. In particular, the pretreatment gas comprises argon and/or nitrogen and/or another inert gas and at least one substance selected from water, oxygen, and hydrogen.

In a preferred embodiment of the method, the pretreatment gas comprises argon and oxygen, preferably the pretreatment gas consists of argon and oxygen. During treatment with the pretreatment gas, the surfaces of the particles of the magnetic base material oxidize. Thereby, finely distributed rare-earth oxides, in particular neodymium oxides, which have a lower electrical conductance than the magnetic base material, which is preferably in a hydrogenated form, are preferably formed on the surfaces. After sintering, the permanent magnet has finely distributed oxides in its microstructure, which are present at the grain boundaries and thus reduce the overall electrical conductivity of the permanent magnet.

According to a further development of the invention, it is provided that the raw form is produced by means of a method selected from a group consisting of injection molding, in particular metal powder injection molding, additive manufacturing, extrusion, cold pressing, and hot pressing.

In an embodiment of the method, the raw form is produced by injection molding a mixture comprising the magnetic base material and the organic binder. Alternatively or in addition to the organic binder, the mixture preferably comprises at least one organic substance and/or at least one rare-earth compound.

In a further embodiment of the method, the raw form is produced by cold pressing a magnetic base material and preferably at least one organic substance and/or at least one rare-earth compound. In cold pressing, the particles are mechanically interlocked, in particular under a pressure of up to 1 GPa. In dry cold pressing, in particular no additional liquid component is added to the magnetic base material and preferably to the at least one organic substance and/or the at least one rare-earth compound. In wet-cold pressing, an additional liquid component, preferably a volatile nonpolar and/or polar organic solvent, is added in particular to the magnetic base material and preferably to the at least one organic substance and/or the at least one rare-earth compound. The volatile nonpolar and/or polar organic solvent is selected from a group consisting of an alcohol, an acyclic alkane, a cyclic alkane, a ketone, and a mixture of volatile organic substances that can serve as solvents. As an alcohol, ethanol or isopropanol is preferably used. Cyclohexane is preferably used as the cyclic alkane. Acetone is preferably used as the ketone. The mixture of volatile organic substances is preferably selected from a group consisting of petroleum, mineral spirit, and petroleum ether. In particular, the liquid component serves as a binder during wet cold pressing. Furthermore, the raw form is preferably dried before sintering.

In a further embodiment of the method, the raw form is produced by hot pressing a magnetic base material and preferably at least one organic substance and/or at least one rare-earth compound. During hot pressing, the particles are in particular mechanically interlocked and/or cold welded.

According to a further development of the invention, it is provided that the raw form is produced in an externally applied magnetic field. Advantageously, dipoles of the magnetic base material are aligned in a parallel orientation by means of the externally applied magnetic field during the production of the raw form.

Preferably, the externally applied magnetic field is generated by a switchable electromagnet and/or a permanent magnet.

According to a further development of the invention, it is provided that the raw form is exposed to an atmosphere comprising a process gas selected from a group consisting of an argon-containing gas, an oxygen-containing gas, a nitrogen-containing gas, a carbon-containing gas, a fluorine-containing gas, a chlorine-containing gas, a sulfur-containing gas and a hydrogen-containing gas.

In an embodiment of the method, the sintering is performed in an atmosphere comprising the process gas.

In a further embodiment of the method, the organic binder is at least partially removed from the raw form in an atmosphere comprising the process gas.

In a further embodiment of the method, the process gas serves as a reactant and/or a catalyst of the at least one resistance building substance.

In a preferred embodiment of the method, the magnetic base material is mixed with an organic binder and a carbon-containing polymer, wherein a mixture of the magnetic base material, the organic binder and the carbon-containing polymer is obtained. The mixture is used to make the raw form. Subsequently, the binder is at least partially removed under the action of temperature and in an atmosphere comprising the process gases argon and hydrogen. During the removal of the binder, under the influence of the process gases argon and hydrogen, the carbon-containing polymer is additionally incompletely decomposed, and finely distributed rare-earth carbides are formed on the surfaces of the particles of the magnetic base material. These rare-earth carbides accumulate at the grain boundaries of the permanent magnet during sintering and reduce its electrical conductivity.

In another preferred embodiment of the method, the magnetic base material is mixed with an organic binder and a carbon-containing polymer, wherein a mixture of the magnetic base material, the organic binder and the carbon-containing polymer is obtained. The mixture is used to make the raw form. Subsequently, the binder is at least partially removed under the action of temperature and in an atmosphere comprising at least one reaction gas. During the removal of the binder, the magnetic base material oxidizes due to the at least one reaction gas and finely divided rare-earth oxides are formed on the surfaces of the particles of the magnetic base material. After sintering, the permanent magnet exhibits rare-earth oxides in its microstructure, which are present at the grain boundaries and reduce the electrical conductivity of the permanent magnet.

According to a further development of the invention, it is provided that the electrical resistance layer is formed as a completely embracing covering of at least one of the particles of the magnetic base material. Alternatively or additionally, the electrical resistance layer is formed as completely embracing covering of at least one of the grains of the structure of the permanent magnet.

According to a further development of the invention, it is provided that the electrical resistance layer is formed as a non-closed covering of at least one of the particles of the magnetic base material. In particular, the electrical resistance layer is preferably arranged in the form of particles, in particular in the form of finely distributed particles, between the particles of the magnetic base material. Alternatively or additionally, the electrical resistance layer is preferably arranged in the form of particles, in particular in the form of finely distributed particles, between the grains of the microstructure of the permanent magnet.

In a first embodiment of the method, the organic binder and the at least one resistance building substance are mixed, wherein a first mixture is obtained. Particularly preferably, the first mixture has a volume fraction of from 1% to 99% of the at least one resistance building substance. Subsequently, the first mixture and the magnetic base material are mixed, wherein a second mixture is obtained. Particularly preferably, the second mixture has a volume fraction of from 1% to 50% of the first mixture. Preferably, the first mixture and the magnetic base material are mixed at a predetermined temperature of from 20° C. to 250° C. Alternatively or additionally, the first mixture and the magnetic base material are preferably mixed in an inert gas atmosphere, wherein the inert gas atmosphere preferably comprises, preferably consists of, at least one gas selected from a group consisting of argon and nitrogen. Alternatively or additionally, the first mixture and the magnetic base material are preferably mixed in an atmosphere comprising hydrogen, more preferably consisting of hydrogen. Alternatively or additionally, the first mixture and the magnetic base material are preferably mixed in a vacuum. Subsequently, the second mixture is formed into shape, wherein the raw form is created. In an optional pre-debinding step, preferably at least a portion of the organic binder is removed from the raw form, wherein the at least one resistance building substance remains in the raw form. Preferably, at least one process selected from a group consisting of a solvent extraction, a chemical decomposition, and a thermal decomposition is performed during the pre-debinding step. In a thermal debinding step, which is preferably performed after the pre-debinding step, the organic binder and the at least one resistance building substance are incompletely decomposed, wherein at least one element selected from a group consisting of carbon, fluorine, chlorine, bromine, iodine, nitrogen, silicon, boron, and sulfur remains in the raw form and reacts with the magnetic base material to obtain an electrically poorly conductive compound. Preferably, the thermal debinding is carried out in an inert gas atmosphere, wherein the inert gas atmosphere preferably comprises, preferably consists of, at least one gas selected from a group consisting of argon and helium. Alternatively, the thermal debinding is carried out in an atmosphere comprising hydrogen, more preferably consisting thereof. Alternatively, the thermal debinding is preferably carried out in a vacuum. Preferably, the electrically poorly conducting chemical compound of the at least one element remaining in the raw form accumulates with the magnetic base material in the grain boundaries of the microstructure. Thereafter, particularly preferably, the debindered raw form is sintered at a temperature of 1000° C. to 1200° C. for a duration of 30 min to 300 min Particularly preferably, the sintering is carried out in an inert gas atmosphere, wherein the inert gas atmosphere preferably comprises, preferably consists of, at least one gas selected from a group consisting of argon and helium. Alternatively, the sintering is preferably carried out in a vacuum.

In a particularly preferred configuration of the first embodiment of the method, at least one backbone polymer, in particular at least one organic polymer, as the resistance building substance is mixed with at least one base polymer, in particular at least one organic polymer, as the organic binder, wherein the first mixture is obtained. Preferably, the second mixture has the magnetic base material at a volume fraction of from 30% to 70%. During the pre-debinding step, the at least one base polymer is dissolved out of the raw form. Alternatively, during the pre-debinding, the at least one base polymer is chemically or thermally decomposed. Additionally, the pre-debinding is preferably performed such that the at least one backbone polymer remains in the raw form. Preferably, the thermal debinding is carried out in a hydrogen atmosphere, wherein preferably the hydrogen atmosphere additionally comprises at least one gas selected from argon and helium. Alternatively or additionally, the thermal debinding is carried out at a temperature of 150° C. to 900° C. Preferably, the thermal debinding is carried out for a duration of 3 h to 16 h, wherein particularly preferably at least one predetermined temperature of 300° C. to 800° C., in particular at least one predetermined temperature selected from a group consisting of 300° C., 350° C., 400° C., 450° C., 500° C., 550° C., 600° C., 650° C., 700° C., 750° C. and 800° C., is kept constant for a duration of 30 min to 180 min. Advantageously, the at least one backbone polymer decomposes incompletely due to the temperature and an interaction with the hydrogen and preferably the at least one gas selected from argon and helium, wherein the debindered raw form advantageously comprises carbon at a volume fraction of 0.01% to 3.0%. The at least one incompletely decomposed backbone polymer advantageously reacts with the magnetic base material, wherein in particular finely divided rare-earth carbides are formed. These rare-earth carbides accumulate at the grain boundaries of the permanent magnet during sintering and reduce its electrical conductivity.

In a second embodiment of the method, the magnetic base material is mixed with at least one resistance building substance which has a low electrical conductance, in particular an electrical conductance of less than 10⁻⁶ Siemens per meter, in particle form—in particular, the particles of the at least one resistance building substance have a particle size of 0.01 μm to 20 μm. Particularly preferably, the at least one resistance building substance comprises at least one compound selected from a group consisting of a carbon-containing rare-earth compound, a sulfur-containing rare-earth compound, an oxygen-containing rare-earth compound, a nitrogen-containing rare-earth compound, a boron-containing rare-earth compound, a silicon-containing rare-earth compound, a fluorine-containing rare-earth compound, a chlorine-containing rare-earth compound, aluminium oxide, zirconium oxide and titanium oxide. Alternatively, the at least one resistance building substance preferably consists of at least one compound selected from a group consisting of a carbon-containing rare-earth compound, a sulfur-containing rare-earth compound, an oxygen-containing rare-earth compound, a nitrogen-containing rare-earth compound, a boron-containing rare-earth compound, a silicon-containing rare-earth compound, a fluorine-containing rare-earth compound, a chlorine-containing rare-earth compound, aluminium oxide, zirconium oxide and titanium oxide. Preferably, the magnetic base material and the at least one resistance building substance are mixed together with an organic binder, in particular an organic polymer, wherein a third mixture is obtained. Alternatively, the magnetic base material and the at least one resistance building substance are preferably first dry mixed, wherein a dry mixture is obtained, and thereafter the dry mixture is mixed with the organic binder, in particular the organic polymer, wherein the third mixture is obtained. The at least one resistance building substance particularly preferably has a volume fraction of 0.01% to 10% of the total volume of the magnetic base material and the at least one resistance building substance. Particularly preferably, at least one operation selected from dry mixing and preparation the third mixture is carried out at a temperature of 20° C. to 200° C. Alternatively or additionally, preferably at least one operation selected from the dry mixing and the preparation of the third mixture is carried out in an inert gas atmosphere, wherein the inert gas atmosphere preferably comprises, preferably consists of, at least one gas selected from a group consisting of argon, nitrogen and helium. Subsequently, the third mixture is molded, wherein the raw form is created. In the optional pre-debinding step, preferably at least a portion of the organic binder is removed from the raw form, wherein the at least one resistance building substance remains in the raw form. Preferably, at least one process selected from a group consisting of a solvent extraction, a chemical decomposition, and a thermal decomposition is performed during the pre-debinding step. In the thermal debinding step, which is preferably carried out after the pre-debinding step, the organic binder is preferably removed from the raw form for the most part, particularly preferably completely, wherein the debindered raw form is obtained. The thermal debinding is preferably carried out in an inert gas atmosphere, wherein the inert gas atmosphere preferably comprises, preferably consists of, at least one gas selected from a group consisting of argon and helium. Alternatively, the thermal debinding is carried out in an atmosphere comprising hydrogen, more preferably consisting thereof. Alternatively, the thermal debinding is preferably carried out in a vacuum. Preferably, the particles of the at least one resistance building substance accumulate in the grain boundaries of the microstructure. Thereafter, particularly preferably, the debindered raw form is sintered at a temperature of 1000° C. to 1200° C. for a duration of 30 min to 300 min. Particularly preferably, the sintering is carried out in an inert gas atmosphere, wherein the inert gas atmosphere preferably comprises, preferably consists of, at least one gas selected from a group consisting of argon and helium. Alternatively, the sintering is preferably carried out in a vacuum.

In a particularly preferred configuration of the second embodiment of the method, the magnetic base material, in particular in powdered form, is mixed with the organic binder. In addition, particles of the at least one resistance building substance, which preferably comprises at least one compound selected from a rare-earth oxide, in particular neodymium oxide, and a ceramic, are mixed with the mixture of the magnetic base material and the organic binder. Preferably, the resulting mixture has particles of the at least one resistance building substance at a volume fraction of 0.01% to 10%. Preferably, the mixing operations are carried out at a temperature of 60° C. to 250° C. so that the organic binder is liquid and thus, advantageously, the magnetic base material and the particles are uniformly distributed during mixing.

The problem is also solved by providing a composite material, in particular for a permanent magnet, comprising a magnetic material and an electrically insulating material. An electrical resistance layer formed from the electrically insulating material, which has a lower electrical conductivity than the magnetic material, is arranged between particles of the magnetic material. In particular, the electrically insulating material at least partially, preferably completely, envelops the particles of the magnetic material. Alternatively or additionally, the electrically insulating material is present in particular in the form of finely distributed particles between the particles of the magnetic material. In connection with the composite material, the advantages already explained in connection with the method arise in particular.

In particular, the magnetic material is preferably the magnetic base material described above in connection with the method.

Preferably, the composite material has the electrically insulating material with a volume fraction of 0.01% to 10%.

In particular, the electrically insulating material of the composite material, in particular the electrical resistance layer, is generated by means of the at least one resistance building substance described above in connection with the method. Alternatively or additionally, the electrically insulating material of the composite material is the at least one resistance building substance.

In the context of the present technical teachings, an electrically insulating material has a low electrical conductance, in particular an electrical conductance of less than 10⁻⁶ Siemens per meter. In particular, the composite material comprising the magnetic material and the electrically insulating material has a lower electrical conductance than a material comprising the magnetic material but not the electrically insulating material. Thus, the composite material comprising the magnetic material and the electrically insulating material is less susceptible to eddy currents, and thus heating of the permanent magnets during operation, in particular during operation in an electric motor, is advantageously reduced, in particular avoided.

According to a further development of the invention, it is provided that the magnetic material comprises a neodymium-boron iron alloy.

According to a further development of the invention, it is provided that the electrically insulating material comprises at least one ceramic. Preferably, the at least one ceramic is selected from a group consisting of zirconium oxide, aluminium oxide, titanium oxide and neodymium oxide. Particularly preferably, the electrically conductive material is present in the composite material as particles, in particular in the grain boundary phases.

According to a further development of the invention, it is provided that the electrically insulating material comprises at least one halide. Preferably, the at least one halide is selected from a group consisting of neodymium fluoride, neodymium chloride, dysprosium chloride and praseodymium fluoride. Particularly preferably, the electrically conductive material is present in the composite material as particles, especially in the grain boundary phases.

The invention also includes a permanent magnet produced by means of a method according to the invention or by means of a method according to one or more of the embodiments described above.

The invention also includes a permanent magnet comprising a composite material according to the invention or a composite material according to one or more of the previously described embodiments. Preferably, the permanent magnet comprises a composite material according to the invention or a composite material according to one or more of the previously described embodiments.

The invention further includes a use of such a permanent magnet in a device selected from a group consisting of an electric motor, a speaker, a microphone, a generator, a hard disk drive, and a sensor.

The invention also includes a device selected from a group consisting of an electric motor, a speaker, a microphone, a generator, a hard disk drive, and a sensor, which comprises a permanent magnet provided by means of a method according to the invention or a method according to one of the embodiments described above.

The invention is explained in more detail below with reference to the drawing. Thereby showing:

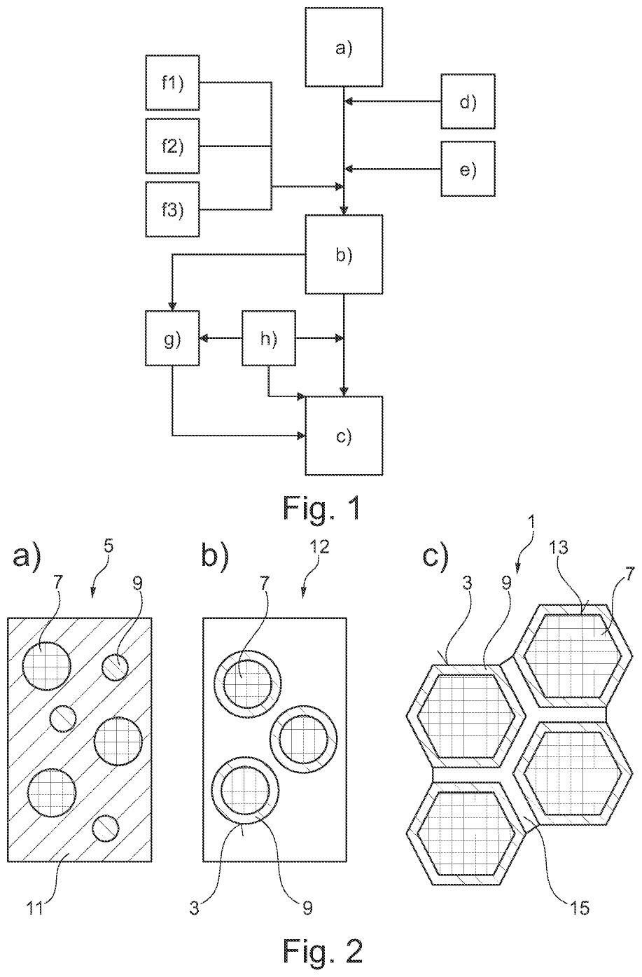

FIG. 1 a flow diagram of a method for producing a permanent magnet with an electrical resistance layer,

FIG. 2 a schematic representation of a first embodiment of a method for producing a first embodiment of a permanent magnet with an electrical resistance layer,

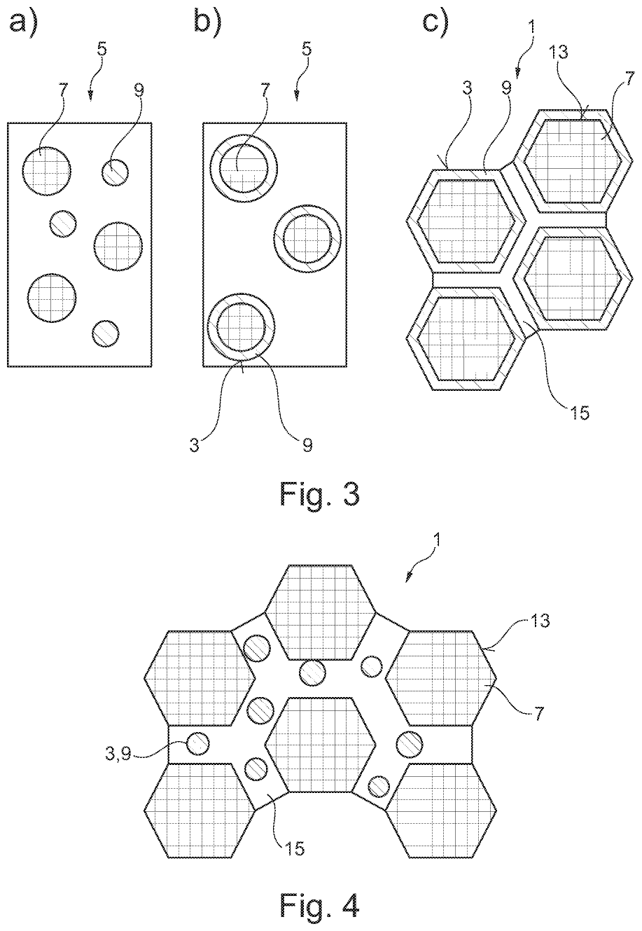

FIG. 3 a schematic representation of a second embodiment of a method for producing the first embodiment of a permanent magnet with an electrical resistance layer, and

FIG. 4 a schematic representation of a second embodiment of a permanent magnet with an electrical resistance layer.

FIG. 1 shows a flow diagram of a method for producing a permanent magnet 1 with an electrical resistance layer 3 shown in FIG. 2. In step a), the magnetic base material 7 is provided, preferably in powdered form. In step b), the magnetic base material 7 is shaped, wherein a raw form 12, also shown in FIG. 2, is created. The raw form 12 is preferably produced by a process selected from a group consisting of injection molding, additive manufacturing, extrusion, cold pressing, and hot pressing. Optionally, the raw form 12 is produced under an externally applied magnetic field, preferably the magnetic field is generated by a switchable electromagnet and/or a permanent magnet. In step c), the raw form 12 is sintered, wherein the permanent magnet 1 is produced. In at least one step of the method, an electrical resistance layer 3 having a lower electrical conductivity than the magnetic base material 7 is formed between particles of the magnetic base material 7.

Preferably, the raw form 12 comprises the magnetic base material 7 with a volume fraction of 30% to 70%.

Preferably, the raw form 12 is sintered in the step c) at a temperature of 1000° C. to 1200° C. for a preferred duration of 30 minutes to 300 minutes.

Between step a) and step b), the following method steps d), e) and f1) to f3)—individually or in combination with each other—can optionally be carried out:

In step d), the magnetic base material 7 is pretreated with a pretreatment gas, wherein the electrical resistance layer 3 is generated by means of the pretreatment gas. Preferably, the pretreatment gas is selected from a group consisting of an argon-containing gas, an oxygen-containing gas, a nitrogen-containing gas, a carbon-containing gas, a fluorine-containing gas, a chlorine-containing gas, a sulfur-containing gas, and a hydrogen-containing gas. In particular, the pretreatment gas comprises argon and/or nitrogen and/or another inert gas, and at least one substance selected from water, oxygen, and hydrogen. In a preferred embodiment of the method, the pretreatment gas comprises argon and oxygen. In a preferred embodiment of the method, the pretreatment gas consists of argon and oxygen. During treatment with the pretreatment gas, the surfaces of the particles of the magnetic base material 7 oxidize, forming finely distributed rare-earth oxides on the surfaces, which have a lower electrical conductance than the magnetic base material 7. Preferably, the magnetic base material 7 is treated with the pretreatment gas at a temperature of from 20° C. to 250° C., particularly preferably from 100° C. to 250° C.

In step e), the magnetic base material 7 is mixed with an organic binder 11, wherein a mixture 5 of the magnetic base material 7 and the organic binder 11 is obtained. In this case, the raw form 12 is created from the mixture 5 in step b). Preferably, the electrical resistance layer 3 is formed from the organic binder 11. Preferably, the magnetic base material 7 is mixed with the organic binder 11 at a temperature of from 20° C. to 250° C., more preferably from 60° C. to 200° C. Preferably, when the electrical resistance layer 3 is formed from the organic binder 11, the raw form 12 obtained in step b) has the organic binder 11 in a volume fraction of from 0.01% to 50%, preferably from 1% to 10%.

In steps f1) to f3)—which can be carried out individually or in combination with one another—the magnetic base material 7 is mixed with at least one resistance building substance 9, wherein the electrical resistance layer 3 is formed from the at least one resistance building substance 9. The at least one resistance building substance 9 is selected from a group consisting of an organic substance, a rare-earth compound, a ceramic and a reaction gas. Preferably, the raw form 12 obtained in the step b) has the at least one resistance building substance 9 with a volume fraction of from 0.01% to 50%, preferably from 1% to 10%. Preferably, the at least one resistance building substance 9 is mixed with the magnetic base material 7 and preferably the organic binder 11 at a temperature of from 20° C. to 250° C., particularly preferably from 60° C. to 200° C.

In step f1), the magnetic base material 7 is mixed with an organic substance selected from a group consisting of a solvent, an oxygen-containing polymer, a halogen-containing polymer, a nitrogen-containing polymer, a carbon-containing polymer, a silicon-containing polymer, a sulfur-containing polymer and a boron-containing polymer. In particular, the organic substance is liquid or solid at room temperature. In an embodiment of the method, the organic substance is selected from a group consisting of waxes, thermoplastic resin, alcohols, silicones, and fluorochlorohydrocarbons.

In step f2), the magnetic base material 7 is treated with a rare-earth compound selected from a group consisting of a carbon-containing rare-earth compound, a sulfur-containing rare-earth compound, an oxygen-containing rare-earth compound, a nitrogen-containing rare-earth compound, a boron-containing rare-earth compound, a silicon-containing rare-earth compound, a fluorine-containing rare-earth compound and a chlorine-containing rare-earth compound.

Alternatively or additionally, in step f2), the magnetic base material 7 is mixed with a ceramic, preferably ceramic particles selected from a group consisting of an oxide ceramic—in particular aluminium oxide, zirconium oxide or titanium oxide —, a carbide ceramic and a nitride ceramic.

In step f3), the magnetic base material 7 is mixed with a reaction gas selected from a group consisting of an oxygen-containing gas, a nitrogen-containing gas, a carbon-containing gas, a fluorine-containing gas, a chlorine-containing gas, a sulfur-containing gas, and a hydrogen-containing gas. Preferably, the magnetic base material 7 is treated with the reaction gas at a temperature of from 20° C. to 250° C., particularly preferably from 100° C. to 250° C.

In an embodiment, the at least one resistance building substance 9 forms the electrical resistance layer 3. Alternatively or additionally, at least two resistance building substances 9 react with each other, or the resistance building substance 9 decomposes, or the resistance building substance 9 reacts with another substance, and at least one resulting reaction product forms the electrical resistance layer 3. Alternatively or additionally, the at least one resistance building substance 9 acts as a catalyst in forming the electrical resistance layer 3. Alternatively or additionally, the magnetic base material 7 acts as a catalyst in a reaction of at least two resistance building substances 9, the decay of the resistance building substance 9, or the reaction of the resistance building substance 9 with another substance to form the electrical resistance layer 3.

Optionally, the mixing of the magnetic base material 7 with the at least one resistance building substance 9 is carried out at a temperature of from at least 20° C. to at most 1100° C., preferably from 150° C. to 1100° C. Preferably, the effect of temperature causes activation of the at least one resistance building substance 9. Alternatively or additionally, the at least one resistance building substance 9 decomposes under the effect of temperature to form the electrical resistance layer 3.

Between step b) and step c), the following method steps—individually or in combination with one another—can optionally be carried out:

In step g), an organic binder 11, which was added to the magnetic base material 7 in step e), is at least partially removed. The parts of the organic binder 11 remaining in the raw form 12 remain in the raw form 12 during sintering and are accumulated around the particles of the magnetic base material 7 and/or at the grain boundaries and form the electrical resistance layer 3. It is also possible that the parts of the binder 11 remaining in the raw form 12 are chemically changed during sintering and in this way form the electrical resistance layer 3.

Alternatively, in step g), a liquid component which has been added to the magnetic base material 7, in particular during wet cold pressing, is removed. Preferably, in step g) a thermal debinding is carried out, in particular to thermally decompose the organic binder 11 which is present in the raw form 12. Particularly preferably, the raw form 12 is thermally debinded, in particular thermally decomposed, at a temperature of 150° C. to 900° C. In particular, the thermal debinding, in particular thermal decomposition, is carried out for a duration of 3 hours to 16 hours. Particularly preferably, at least one temperature selected from a group consisting of 150° C., 200° C., 250° C., 300° C., 350° C., 400° C., 450° C., 500° C., 550° C., 600° C., 650° C., 700° C., 750° C., 800° C., 850° C., and 900° C. is kept constant for a duration of 30 minutes to 180 minutes during the thermal debinding.

Prior to and/or during the sintering in step c), the raw form 12 is exposed to a process gas in step h), in particular during the removal of the organic binder 11 or the liquid component in step g).

The process gas is preferably selected from a group consisting of an argon-containing gas, an oxygen-containing gas, a nitrogen-containing gas, a carbon-containing gas, a fluorine-containing gas, a chlorine-containing gas, a sulfur-containing gas and a hydrogen-containing gas. Preferably, the process gas serves as a reactant and/or a catalyst of the at least one resistance building substance 9.

FIG. 2 shows a schematic representation of a first embodiment of a method for producing a first embodiment of a permanent magnet 1 having an electrical resistance layer 3.

FIG. 2a) shows a mixture 5 of a magnetic base material 7, preferably an RₓT_{y}B alloy, in particular an NdₓFe_{y}B alloy, a resistance building substance 9 and an organic binder 11. A raw form 12 is produced from the mixture 5 by a process, preferably selected from a group consisting of injection molding, additive manufacturing, extrusion, cold pressing, and hot pressing.

Preferably, the mixture 5 is prepared by mixing the magnetic base material 7, the resistance building substance 9, and the organic binder 11 in one step. Alternatively, preferably the magnetic base material 7 is first mixed with the organic binder 11 and then the resistance building substance 9 is added. Alternatively, a dry mixture is preferably prepared from the magnetic base material 7 and the resistance building substance 9, and then the dry mixture is mixed with the organic binder 11.

FIG. 2b) shows the raw form 12 after at least partial removal of the organic binder 11. The at least partial removal of the organic binder 11 was carried out under the effect of temperature, preferably from at least 20° C. to at most 1100° C. Alternatively, the organic binder is partially removed from the raw form by solvent extraction. Thereafter, the organic binder is removed from the raw form by means of thermal decomposition. Alternatively, the organic binder is chemically cleaved by means of a chemical reaction. Thereafter, the organic binder is removed from the raw form by means of thermal decomposition.

During the at least partial removal of the organic binder 11 under the effect of temperature, the electrical resistance layer 3 is formed around the particles of the magnetic base material 7—in particular from the binder 11 itself, or by decomposition of the binder 11, or by reaction of the binder 11 with the resistance building substance 9. Alternatively or additionally, the resistance building substance 9 reacts with the particles of the magnetic base material 7 to form the electrical resistance layer 3.

FIG. 2c) shows the permanent magnet 1 after sintering. The particles of the magnetic base material 7 form grains 13, in particular RₓT_{y}B grains. The grains 13 are each enclosed by the electrical resistance layer 3. An additional phase 15, in particular a rare-earth-rich phase, is formed between the grains 13 with the electrical resistance layer 3.

FIG. 3 shows a schematic representation of a second embodiment of a method for producing the first embodiment of a permanent magnet 1 with an electrical resistance layer 3.

In FIG. 3a) a mixture 5 of a magnetic base material 7, preferably of an RₓT_{y}B alloy, in particular of an NdₓFe_{y}B alloy, and a resistance building substance 9 is shown.

In FIG. 3b) the mixture 5 is shown after a reaction of the resistance building substance 9 with the particles of the magnetic base material 7. The resistance building substance 9 accumulates around the particles of the magnetic base material 7 to form the electrical resistance layer 3. Alternatively or additionally, the resistance building substance 9 reacts with the particles of the magnetic base material 7 to form the electrical resistance layer 3.

FIG. 3c) shows the permanent magnet 1 after the raw form 12 has been produced and sintered. The particles of the magnetic base material 7 form grains 13, in particular RₓT_{y}B grains. The grains 13 are each enclosed by the electrical resistance layer 3. The additional phase 15, in particular a rare-earth-rich phase, is formed between the grains 13 with the electrical resistance layer 3.

FIG. 4 shows a schematic diagram of a second embodiment of a permanent magnet 1 with an electrical resistance layer 3. A resistance building substance 9 is deposited between the grains 13 of the magnetic base material 7 as the electrical resistance layer 3. In this case, the resistance building substance 9 is embedded in the additional phase 15, in particular a rare-earth-rich phase. The additional phase 15 is preferably a thin layer at the grain boundaries of the microstructure of the permanent magnet 1.

1. Method of producing a permanent magnet from a powdered magnetic base material, wherein
the powdered magnetic base material is shaped, wherein a raw form is prepared, wherein
the raw form is sintered, wherein the permanent magnet is produced, wherein
in at least one step of the method, between particles of the powdered magnetic base material an electrical resistance layer having a lower electrical conductivity than the powdered magnetic base material is formed.

2. Method according to claim 1, wherein as magnetic base material a material is used which is made of particles of RₓT_{y}B alloy and preferably particles of rare-earth-rich phase.

3. Method according to claim 1, wherein the magnetic base material is mixed with an organic binder, wherein a mixture of the magnetic base material) and the organic binder is obtained, wherein the raw form is prepared from the mixture, wherein the organic binder is at least partially removed from the raw form before sintering.

4. Method according to claim 1, wherein the electrical resistance layer is formed from the organic binder.

5. Method according to claim 1, wherein the magnetic base material is mixed with at least one resistance building substance, wherein the electrical resistance layer is formed from the at least one resistance building substance, wherein the at least one resistance building substance is preferably selected from a group consisting of an organic substance, a rare-earth compound, a ceramic, and a reaction gas.

6. Method according to claim 1, wherein the organic substance is selected from a group consisting of a solvent, an oxygen-containing polymer, a halogen-containing polymer, a nitrogen-containing polymer, a carbon-containing polymer, a silicon-containing polymer, a sulfur-containing polymer, and a boron-containing polymer.

7. Method according to claim 1, wherein the rare-earth compound is selected from a group consisting of a carbon-containing rare-earth compound, a sulfur-containing rare-earth compound, an oxygen-containing rare-earth compound, a nitrogen-containing rare-earth compound, a boron-containing rare-earth compound, a silicon-containing rare-earth compound, a fluorine-containing rare-earth compound and a chlorine-containing rare-earth compound.

8. Method according to claim 1, wherein the ceramic is selected from a group consisting of an oxide ceramic, a carbide ceramic, and a nitride ceramic.

9. Method according to claim 1, wherein the reaction gas is selected from a group consisting of an oxygen-containing gas, a nitrogen-containing gas, a carbon-containing gas, a fluorine-containing gas, a chlorine-containing gas, a sulfur-containing gas, and a hydrogen-containing gas.

10. Method according to claim 1, wherein the mixing of the magnetic base material with the at least one resistance building substance is carried out at a temperature of at least 20° C. to at most 1100° C.

11. Method according to claim 1, wherein the magnetic base material is pretreated with a pretreatment gas, wherein the electrical resistance layer is generated by means of the pretreatment gas.

12. Method according to claim 1, wherein the raw form is produced by means of a process selected from a group consisting of injection molding, additive manufacturing, extrusion, cold pressing, and hot pressing.

13. Method according to claim 1, wherein the raw form is produced in an externally applied magnetic field.

14. Method according to claim 1, wherein the raw form is exposed to an atmosphere comprising a process gas selected from a group consisting of an argon-containing gas, an oxygen-containing gas, a nitrogen-containing gas, a carbon-containing gas, a fluorine-containing gas, a chlorine-containing gas, a sulfur-containing gas, and a hydrogen-containing gas.

15. Method according to claim 1, wherein the electrical resistance layer is formed as completely embracing covering of at least one of the particles of the magnetic base material.

16. Method according to claim 1, wherein the electrical resistance layer is formed as a non-closed covering of at least one of the particles of the magnetic base material, wherein the electrical resistance layer is preferably in the form of particles, preferably finely distributed particles, wherein the particles of the electrical resistance layer are arranged between the particles of the magnetic base material.

17. Composite material, in particular for a permanent magnet, wherein the composite material comprises a magnetic material and an electrically insulating material, wherein an electrical resistance layer formed from the electrically insulating material is arranged between particles of the magnetic material and has a lower electrical conductivity than the magnetic material, wherein in particular the electrically insulating material at least partially surrounds the particles of the magnetic material or is present in the form of finely distributed particles between the particles of the magnetic material.

18. Permanent magnet produced by a method according to claim 1.

19. Permanent magnet comprising a composite material according to claim 17.
